(19) United States
(12) Patent Application Publication
(10) Pub. No.: US 2023/0020275 A1
(43) Pub. Date: Jan. 19, 2023

(54) PROXIMITY SENSING DEVICE

(71) Applicant: Luxsentek Microelectronics Corp., New Taipei City (TW)

(72) Inventors: WEN-SHENG LIN, New Taipei City (TW); SHENG-CHENG LEE, New Taipei City (TW); CHIH-WEI LIN, New Taipei City (TW); CHEN-HUA HSI, New Taipei City (TW); YUEH-HUNG HOU, New Taipei City (TW)

(21) Appl. No.: 17/483,227

(22) Filed: Sep. 23, 2021

(30) Foreign Application Priority Data
Jul. 14, 2021 (TW) 110125890

(51) Int. Cl. G01S 7/497; G01S 17/04

(52) U.S. Cl. CPC G01S 7/497; G01S 17/04

(57) ABSTRACT

The present invention provides a proximity sensing device with linear electrical offset calibration, which can record electrical offsets caused by different dark currents under different settings of the pulse count or the pulse time, and the proximity sensing device uses these electrical offsets to obtain the linear electrical offset ratio. Then calculate and infer the electrical offset generated in actual use through the linear electrical offset ratio to calibrate sensing signal.

### BACKGROUND OF THE INVENTION

### 1. Field of the Invention

The present invention generally relates to a proximity sensing device, and particularly to the proximity sensing device with linear electrical offset calibration.

### 2. Description of the Prior Art

A proximity sensing device irradiates light through an emitting element, usually infrared ray, on an object, reflected by the object, and received by a sensing element. The sensing element converts the reflection light into an electrical signal. A control unit interprets the electrical signal to have a specific sensing function. For example, the emitting element is a LED or Vertical Cavity Surface Emitting Laser (VCSEL), and the sensing element is a photodiode.

The sensing element is subjected to factors such as ambient light, crosstalk of reflected light from the light source, ambient temperature, and circuit-self signal to induce a leakage current or called the dark current. It mixes with the current induced by the reflection of the detection light, i.e. the dark current interferes with the sensing current, and that seriously affects the sensitivity and accuracy of the sensing element.

Usually, the proximity sensing device uses different pulse count (Pulc) or pulse width (Pulw) for different applications, wherein Pulc is the amount of the pulse and Pulw is the duty time for each pulse. Different Pulc or Pulw induces different dark current to causes different electrical offset to have different impact on the interpretation of the sensed distance.

### SUMMARY OF THE INVENTION

The present invention provides a linear model of calibration for a proximity sensing device to calibrate the electrical offset caused by dark currents under different the pulse count (Pulc) or the pulse width (Pulw). The linear model uses determined electrical offsets to approach the testing offsets by a specific ratio to quickly calculate the electrical offset, and then generates the calibration value to improve the accuracy of distance interpretation.

A proximity sensing device, comprising:
a control module;
a light emitting module, comprising a light emitting element and a driver, the driver is coupled between the light-emitting element and the control module, wherein the driver receives a light control signal from the control module to drive the light emitting element to emit a detection light;
a light receiving module configured to receive a reflection light of the detection light from the object and generate a light sensing signal, or generate a first dark current signal and a second dark current signal without the reflection light;
a current-to-voltage converter connected to the light receiving module, the current-to-voltage converter is configured to receive and convert the light sensing signal or the first dark current signal and the second dark current signal to a light analog signal or a first dark current analog signal and a second dark current analog signal; and
an analog-to-digital converter coupled between the current-to-voltage converter and the control module, the analog-to-digital converter is configured to receive and convert the light analog signal or the first dark current analog signal and the second dark current analog signal to a light digital signal or a first dark current digital signal and a second dark current digital signal;
wherein the control module generates a linear electrical offset ratio based on the first dark current digital signal and the second dark current digital signal, calculates a light sensing electrical offset value through the linear electrical offset ratio, and obtains a calibrated light digital signal by subtracting the light sensing electrical offset value from the light digital signal.

### BRIEF DESCRIPTION OF THE DRAWINGS

FIG. 1 is a schematic diagram to show the basic architecture of a proximity sensing device.

FIG. 2 is a timing diagram of the linear electrical offset calibration of the proximity sensing device.

FIG. 3 is a calibration flow chart of the proximity sensing device.

FIG. 4 is a linear diagram of electrical offsets for non-calibrated and calibrated cases.

### DESCRIPTION OF THE PREFERRED EMBODIMENTS

Below embodiments accompanied with drawings are used to explain the spirit of this invention to have better understanding for the person in this art, not used to limit the scope of this invention, which is defined by the claims. The applicant emphasizes the element quantity and size are schematic only. Moreover, some parts might be omitted to skeletally represent this invention for conciseness.

The driver drives the light emitting element in the power of the product of the pulse count (Pulc) and the pulse width (Pulw). However, that induces a dark current, and the dark current is also sensed by the light sensing element (photodiode). It causes an offset of the sensed electrical signal. The present invention proposes a linear calibration model to the electrical offset.

First, the device drives the light emitting element by two or more Pulc and Pulw, and records the sensed electrical offsets (i.e. the sensed intensity), which is purely caused by the dark current. Then, the device uses the sensed electrical offset to obtain a specific electrical offset ratio by a linear approach (i.e. driven power to the dark current is set to be linear). In practice, the device uses the specific electrical offset ratio to calculate the electrical offset for a driven power, and then generate the calibration signal accordingly. It just needs two measurements to obtain the electrical offset ratio to speed up the calibration and to improve the accuracy of the distance interpretation.

In application, the proximity sensing device enters the calibration mode to get the electrical offset ratio when it starts up or after a certain period and then enters the operation mode. In operation, the sensed signal can be calibrated by subtracting an electrical offset, which is calculated according to the electrical offset ratio. In the calibration mode, the time required to obtain the linear electrical offset ratio is two pulse time and ADC converting time, so it is very fast and no-feeling to the users.

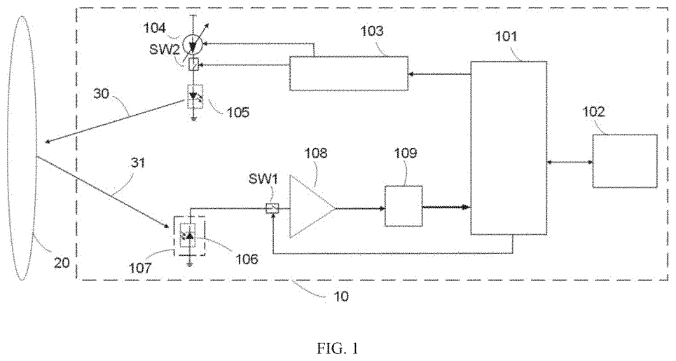

FIG. 1, a schematic diagram, shows the basic architecture of a proximity sensing device. The proximity sensing device 10 comprises a control module, a light emitting module, a light receiving module 106, a current-to-voltage converter (I/V converter) 108 and an analog-to-digital converter (ADC) 109. The control module comprises a microcontroller 101, a digital signal processing unit 102, and a timing controller 103.

The light emitting module comprises the light emitting element 105 and the diver 104, the driver 104 is coupled between the light-emitting element 105 and the timing controller 103. The light emitting element 105 is driven by the driver 104, which receives a light control signal from the timing controller 103. The light control signal comprises the pulse count and the pulse time (pulse width). In general, the total driven power is the product of the pulse amount, the pulse intensity, and the pulse width. In this embodiment, the pulse intensity and pulse count are fixed, but the pulse width varies. In another embodiment, the pulse width and the pulse intensity are fixed, but pulse count varies. The linear model is the sensed dark current and the driven power is set to be linear, so the device obtain the calibration value quickly.

The light receiving module 106 converts the received light into a light sensing signal (i.e. light current), wherein the received light totally comprises a reflection light 31 of the detection light 30 from the object 20 and its interferences. When no reflection light 31, the light receiving module 106 generates at least two dark currents, which comprise a first dark current signal and a second dark current signal. The filter 107 can be optionally arranged around the light receiving module 106 to avoid light crosstalk or interference caused by different colors.

The I/V converter 108 is connected to the light receiving module 106, the current-to-voltage converter 108 is configured to receive and convert the light sensing signal or the first dark current signal and the second dark current signal to a light analog signal or a first dark current analog signal and a second dark current analog signal. The ADC 109 is coupled between the I/V converter 108 and the microcontroller 101, the ADC 109 is configured to receive and convert the light analog signal or the first dark current analog signal and the second dark current analog signal to a light digital signal or a first dark current digital signal and a second dark current digital signal. The microcontroller 101 is configured to receive the light digital signal or the first dark current digital signal and the second dark current digital signal.

The light digital signal has a light sensing value corresponding to the pulse count and the pulse time. The first dark current digital signal has a first dark current electrical offset value corresponding to a first sensing count and a first sensing time. The second dark current digital signal has a second dark current electrical offset value corresponding to a second sensing count and a second sensing time. When the first sensing time and the second sensing time are the same as the pulse time, the first sensing count and the second sensing count are different. And when the first sensing count and the second sensing count are the same as the pulse count, the first sensing time and the second sensing time are different. Wherein the first sensing time and the second sensing time are multiples of 5 ns, and the pulse count, the first sensing count, and the second sensing count are multiples of 2.

In one embodiment, the first switch unit (SW1) is coupled between the light receiving module 106 and the I/V converter 108, and the second switch unit (SW2) is coupled between the driver 104 and the light emitting element 105. The first switch unit (SW1) and the second switch unit (SW2) are controlled by the microcontroller 101 to switch to open or close (circuit). The SW1 is switched to close and the SW2 is switched to open, the proximity device enters the calibration mode. The SW1 and the SW2 are switched to close, the proximity device enters the operation mode.

In the calibration mode, when the first sensing time and the second sensing time are the same as the pulse time, the digital signal processing unit 102 connected to the microcontroller 101 obtains the linear electrical offset ratio by calculating the difference between the first dark current electrical offset value and the second dark current electrical offset value divided by the difference between the first sensing count and the second sensing count. When the first light sensing count and the second sensing count are the same as the pulse count, the digital signal processing unit 102 obtains the linear electrical offset ratio by calculating the difference between the first dark current electrical offset value and the second dark current electrical offset value divided by the difference between the first sensing time and the second sensing time. Calculates the light sensing electrical offset value corresponding to the pulse count and the pulse time through this linear electrical offset ratio and subtracts the light sensing electrical offset value from the light sensing value to obtain the calibrated light digital signal. The proximity device enters the operation mode after the calibration. The microcontroller 101 further comprises an internal memory to store the linear electrical offset ratio and the light sensing electrical offset value.

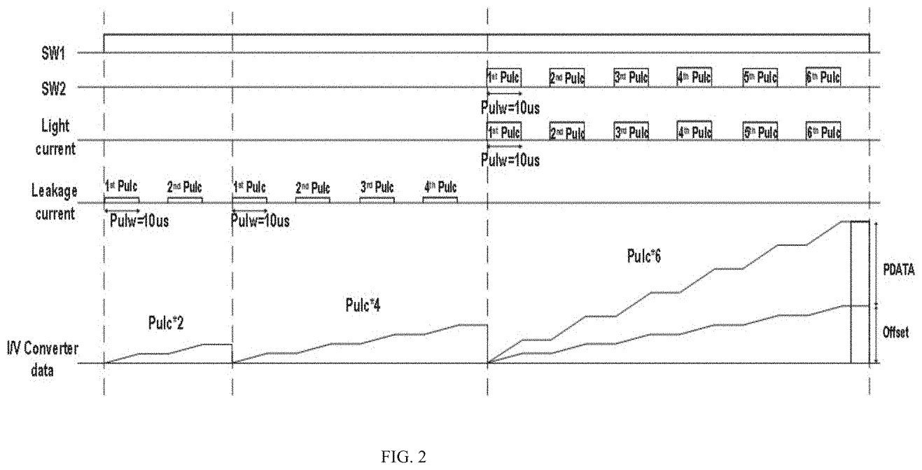

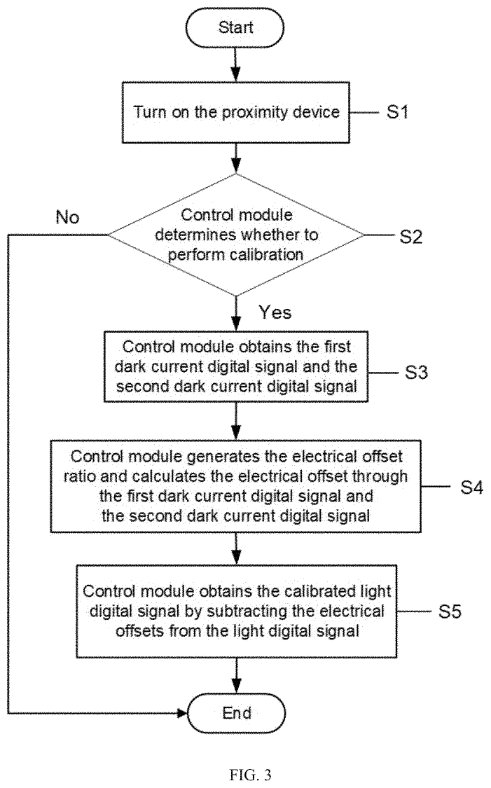

FIG. 2 and FIG. 3, the timing diagram and the flow chart of the linear electrical offset calibration. In this embodiment, the first sensing time and the second sensing time are the same as the pulse time, 10 μs. Referring to FIG. 3, first, turn on the proximity sensing device (step S1), perform the calibration by the determination of the microcontroller without receiving the reflectance light (step S2). The microcontroller obtains a first dark current electrical offset value, which the first sensing count is twice (Pulc*2), and then obtains the second sensing count, which the second sensing count is four times (Pulc*4) (step S3).

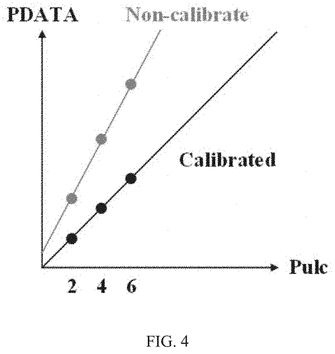

The proximity sensing device can get a light sensing value which its pulse count is six times (Pulc*6) after the linear electrical offset ratio is obtained by the following formula (1), and the light sensing electrical offset value is obtained by the following formula (2) (step S4). At last, the calibrated light digital signal (PDATA) is obtained by the following formula (3) (step S5). FIG. 4 shows a linear diagram of electrical offsets for non-calibrated and calibrated cases.

Linear electrical offset ratio=(The second dark current electrical offset value−The first dark current electrical offset value)/(4−2) (1)

Light sensing electrical offset value=(Light sensing value)*(Linear electrical offset ratio) (2)

Calibrated light digital signal=(Light sensing value)−(Light sensing electrical offset value) (3)

The above embodiments are at a fixed Pulw, measuring the dark current generated by more than two different Pulc, and calculating the linear electrical offset ratio. In different embodiments, a fixed Pulc can be used to measure the dark current generated by more than two different Pulw and can also calculate the linear electrical offset ratio.

1. A proximity sensing device, comprising:
a control module;
a light emitting module, comprising a light emitting element and a driver, the driver is coupled between the light-emitting element and the control module, wherein the driver receives a light control signal from the control module to drive the light emitting element to emit a detection light;
a light receiving module configured to receive a reflection light of the detection light from the object and generate a light sensing signal, or generate a first dark current signal and a second dark current signal without the reflection light;
a current-to-voltage converter connected to the light receiving module, the current-to-voltage converter is configured to receive and convert the light sensing signal or the first dark current signal and the second dark current signal to a light analog signal or a first dark current analog signal and a second dark current analog signal; and
an analog-to-digital converter coupled between the current-to-voltage converter and the control module, the analog-to-digital converter is configured to receive and convert the light analog signal or the first dark current analog signal and the second dark current analog signal to a light digital signal or a first dark current digital signal and a second dark current digital signal;
wherein the control module generates a linear electrical offset ratio based on the first dark current digital signal and the second dark current digital signal, calculates a light sensing electrical offset value through the linear electrical offset ratio, and obtains a calibrated light digital signal by subtracting the light sensing electrical offset value from the light digital signal.

2. The proximity sensing device according to claim 1, wherein the control module comprises:
a microcontroller is configured to receive the light digital signal or the first dark current digital signal and the second dark current digital signal;
a digital signal processing unit connects to the microcontroller, generates the linear electrical offset ratio based on the first dark current digital signal and the second dark current digital signal, calculates the light sensing electrical offset value through the linear electrical offset ratio, and obtains the calibrated light digital signal by subtracting the light sensing electrical offset value from the light digital signal; and
a timing controller couples between the microcontroller and the driver, the timing controller is configured to output the light control signal to the driver.

3. The proximity sensing device according to claim 2, wherein the microcontroller comprises an internal memory to store the linear electrical offset ratio and the light sensing electrical offset value.

4. The proximity sensing device according to claim 1, wherein the light control signal comprises a pulse count and a pulse time.

5. The proximity sensing device according to claim 4, wherein the light digital signal has a light sensing value corresponding to the pulse count and the pulse time, the control module calculates the light sensing electrical offset value corresponding to the pulse count and the pulse time though the linear electrical offset ratio, and the control module obtains the calibrated light digital signal by subtracting the light sensing electrical offset value from the light digital signal.

6. The proximity sensing device according to claim 4, wherein the first dark current digital signal has a first dark electrical offset value corresponding to a first sensing count and a first sensing time, and the second dark current digital signal has a second dark current electrical offset value corresponding to the second sensing count and a second sensing time.

7. The proximity sensing device according to claim 6, when the first sensing time and the second sensing time are the same as the pulse time, the first sensing count and the second sensing count are different, wherein the linear electrical offset ratio is the difference between the first dark current electrical offset value and the second dark current electrical offset value divided by the difference between the first sensing count and the second sensing count.

8. The proximity sensing device according to claim 6, when the first sensing count and the second sensing count are the same as the pulse count, the first sensing time and the second sensing time are different, wherein the linear electrical offset ratio is the difference between the first dark current electrical offset value and the second dark current electrical offset value divided by the difference between the first sensing time and the second sensing time.

9. The proximity sensing device according to claim 7, wherein the pulse time, the first sensing time and the second sensing time are multiples of 5 μs, and the pulse count, the first sensing count, and the second sensing count are multiples of 2.

10. The proximity sensing device according to claim 1, further comprising:
a first switch unit is coupled between the light receiving module and the current-to-voltage converter;
a second switch unit is coupled between the light emitting element and the driver; and
wherein the first switch unit and the second switch are controlled by the control module to switch to close or open.

11. The proximity sensing device according to claim 10, wherein the proximity device enters a calibration mode when the control module switches the second switch unit to open and switches the first switch unit to close, and the proximity device enters an operation mode when the control module switches the second switch unit and the first switch unit to close.
